(19) United States
(12) Patent Application Publication
(10) Pub. No.: US 2026/0093113 A1
(43) Pub. Date: Apr. 2, 2026

(54) OPTICAL FILM

(71) Applicant: AUO Corporation, Hsinchu City (TW)

(72) Inventors: Yueh-Heng Lee, Hsinchu City (TW); Chia-Hung Chen, Hsinchu City (TW); Shih-Fu Tseng, Hsinchu City (TW)

(73) Assignee: AUO Corporation, Hsinchu City (TW)

(21) Appl. No.: 19/317,020

(22) Filed: Sep. 2, 2025

(30) Foreign Application Priority Data
Sep. 27, 2024 (TW) 113136926

(51) Int. Cl. G02B 27/01; G02B 5/04

(52) U.S. Cl. CPC G02B 27/0101; G02B 5/045; G02B 2027/0118

(57) ABSTRACT

An optical film including a first substrate and a plurality of prism structures is provided. The plurality of prism structures are arranged on a first substrate surface of the first substrate along a first direction and extend along a second direction. The first substrate has a first side edge and a second side edge on opposite sides thereof along the first direction. Each of the prism structures has a structural height relative to the first substrate surface, and the structural height of each prism structure increases first and then decreases from the first side edge toward the second side edge.

### CROSS-REFERENCE TO RELATED APPLICATION

This application claims the priority benefit of Taiwan application serial no. 113136926, filed on Sep. 27, 2024. The entirety of the above-mentioned patent application is hereby incorporated by reference herein and made a part of this specification.

### BACKGROUND

### Technical Field

The disclosure relates to an optical film, and more particularly to an optical film provided with prism structures.

### Description of Related Art

Advancements in display technology have driven the development of in-vehicle display applications. Among them, head-up displays (HUDs) that use the vehicle windshield as a projection screen have become one of the key focuses for related manufacturers. In general, the light source module used in a HUD is typically equipped with a prism sheet for light-condensing functionality and a brightness enhancement film to improve optical energy utilization, and it provides a certain degree of light output uniformity. However, since most vehicle windshields are free-form surfaces and are often provided with special reflective coatings, these reflective coatings further alter the reflective properties of the windshield, resulting in different reflectance levels under different conditions of light (e.g., different polarization states or incident angles). As a result, although the light emitted from the light source module is uniform, the virtual image formed by the reflection on the windshield may suffer from reduced brightness uniformity.

### SUMMARY

The disclosure provides an optical film capable of effectively improving the brightness uniformity of an image formed by light reflected from a projection screen.

The disclosure provides an optical film that offers higher process flexibility and a more uniform appearance of the film surface.

An optical film of the disclosure is adapted for use in a light source module and configured corresponding to a projection screen. The projection screen has a viewing area formed by a plurality of eye points. The optical film includes a first substrate and a plurality of prism structures. The first substrate has a first side edge and a second side edge on opposite sides thereof along a first direction. A plurality of prism structures are arranged on a first substrate surface of the first substrate along the first direction and extend along a second direction. The plurality of prism structures includes a first prism structure and a second prism structure having mutually different geometrical shapes. A light source of the light source module is configured to emit a first light ray and a second light ray. The first light ray is incident on a first portion of the projection screen with a first light intensity after passing through the first prism structure. The second light ray is incident on a second portion of the projection screen with a second light intensity after passing through the second prism structure. The first light intensity is not equal to the second light intensity. A portion of a virtual image formed at any one of the plurality of eye points by the first light ray having the first light intensity and reflected from the first portion of the projection screen has a first display brightness. Another portion of the virtual image formed at the any one of the plurality of eye points by the second light ray having the second light intensity and reflected from the second portion of the projection screen has a second display brightness. The first display brightness is equal to the second display brightness.

An optical film of the disclosure includes a first substrate and a plurality of prism structures. The plurality of prism structures are arranged on a first substrate surface of the first substrate along a first direction and extend along a second direction. The first substrate has a first side edge and a second side edge on opposite sides thereof along the first direction. Each of the plurality of prism structures has a structural height relative to the first substrate surface. The structural height of each of the plurality of prism structures increases first and then decreases from the first side edge toward the second side edge.

An optical film of the disclosure includes a substrate and a plurality of prism structures. The substrate has a first side edge and a second side edge on opposite sides thereof along a first direction. The plurality of prism structures are arranged on a substrate surface of the substrate along the first direction and extend along a second direction. Each of the plurality of prism structures has a structural height relative to the substrate surface, and a first structural surface and a second structural surface respectively facing the first side edge and the second side edge. A first angle is included between the first structural surface and the substrate surface. A second angle is included between the second structural surface and the substrate surface. The plurality of prism structures include a plurality of first prism structures, a plurality of second prism structures, and a plurality of third prism structures. At least a portion of the plurality of third prism structures is disposed between each of the plurality of first prism structures and each of the plurality of second prism structures. The first angle of each of the plurality of third prism structures is equal to the first angle of each of the plurality of first prism structures and different from the first angle of each of the plurality of second prism structures. The second angle of each of the plurality of third prism structures is equal to the second angle of each of the plurality of first prism structures and different from the second angle of each of the plurality of second prism structures. The structural height of each of the plurality of third prism structures is less than the structural height of each of the plurality of first prism structures and the plurality of second prism structures.

Based on the above, in the optical film of an embodiment of the disclosure, the geometric shape or structural height of each of the prism structures varies according to its position on the substrate. The geometric shape distribution or structural height distribution of these prism structures allows light passing through the respective structural surfaces to be incident on different portions of the projection screen with different light intensities. After being reflected by different portions of the projection screen, the virtual image formed at any eye point within the viewing area can exhibit a more uniform display brightness distribution. In the optical film of an embodiment of the disclosure, a third prism structure is provided between the first prism structure and the second prism structure having different angles. Since the angle of the third prism structure is the same as that of either the first prism structure or the second prism structure, and the structural height of the third prism structure is less than that of the first prism structure and second prism structure, the region in which the third prism structure is provided can serve as a buffer area for the segmented processing of the first prism structure and second prism structure. This contributes to improved process flexibility, and the produced optical film can have a desirable film surface appearance.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A and FIG. 1B are schematic cross-sectional views of a light source module according to a first embodiment of the disclosure.

FIG. 2 is a schematic top view illustrating the configuration relationship between the optical film and the projection screen in FIG. 1.

FIG. 3A is a schematic diagram illustrating the configuration relationship between the optical film, the projection screen and the viewing area in FIG. 2.

FIG. 3B is a schematic diagram illustrating the configuration relationship between another embodiment of the optical film in FIG. 2, the projection screen and the viewing area.

FIG. 4A to FIG. 4C illustrate light distributions of the light ray after passing through various prism structures in different regions of the optical film in FIG. 1.

FIG. 5A is a display brightness distribution of a virtual image formed at an eye point in the viewing area after light passes through the optical film of FIG. 1 and is reflected by the projection screen.

FIG. 5B is a display brightness distribution of a virtual image formed at an eye point in the viewing area after light passes through an optical film of a comparative example and is reflected by the projection screen.

FIG. 6A and FIG. 6B are schematic cross-sectional views of an optical module of a comparative example.

FIG. 7 is a schematic cross-sectional view of another embodiment of the optical film in FIG. 1A.

FIG. 8A and FIG. 8B are schematic cross-sectional views of a light source module according to a second embodiment of the disclosure.

FIG. 9A to FIG. 9C illustrate light distribution of the light ray after passing through the plurality of prism structures in different regions of the optical film in FIG. 8A and FIG. 8B and the light pattern shifting film.

FIG. 10A and FIG. 10B are schematic cross-sectional views of a light source module according to a third embodiment of the disclosure.

FIG. 11 is a schematic cross-sectional view of a light source module according to a fourth embodiment of the disclosure.

FIG. 12 is a schematic diagram illustrating the configuration relationship between the optical film, the projection screen, and the viewing area in FIG. 11.

FIG. 13 is a schematic cross-sectional view of an optical film according to a fifth embodiment of the disclosure.

FIG. 14 is a schematic cross-sectional view of another embodiment of the optical film in FIG. 13.

FIG. 15 is a schematic cross-sectional view of an optical film according to a sixth embodiment of the disclosure.

### DESCRIPTION OF THE EMBODIMENTS

As used herein, the terms “approximately,” “about,” “substantially,” or “essentially” include the stated values as well as average values within an acceptable deviation range as would be determined by a person skilled in the art, taking into account specific quantities of measurement and the errors associated with measurement (i.e., limitations of the measurement system). For example, “about” may refer to within one or more standard deviations from the stated value, or within ±30%, ±20%, ±15%, ±10%, or ±5%. Furthermore, depending on the nature of the measurement, cutting process, or other relevant properties, the terms “approximately,” “about,” “substantially,” or “essentially” may be interpreted with a selectively acceptable deviation range or standard deviation, and a single standard deviation does not necessarily apply to all properties.

In the drawings, for clarity, the thicknesses of layers, films, panels, and regions are exaggerated. It should be understood that when components such as layers, films, regions, or substrates are described as being “on” or “connected to” another component, they may be directly on or connected to the other component, or intermediate components may also be present. Conversely, when components are described as being “directly on” or “directly connected to” another component, no intermediate components are present. As used herein, “connected” may refer to physical and/or electrical connection. Additionally, “electrically connected” may still allow for other components to exist between the two elements.

Moreover, relative terms such as “lower” or “bottom” and “upper” or “top” may be used herein to describe the relationship between components as shown in the FIGs. It should be understood that such relative terms are intended to encompass different orientations of the device beyond those shown in the drawings. For example, if a device in a drawing is flipped, the component described as being “below” another component may now be positioned “above” it. Thus, exemplary terms such as “lower” may include both “lower” and “upper” orientations, depending on the specific orientation in the FIG.s. Similarly, a component described as being “under” or “beneath” another may also be situated “over” or “above” it if the FIG. is flipped. Therefore, exemplary terms like “above” or “below” may include both orientations.

The exemplary embodiments described herein are referenced to schematic cross-sectional views, which are idealized examples. Variations in the illustrated shapes due to, for example, manufacturing techniques and/or tolerances are to be expected. Therefore, the embodiments described herein should not be construed as limited to the specific shapes illustrated, but rather include shape deviations that result from manufacturing. For instance, regions shown or described as flat may exhibit rough and/or nonlinear characteristics. Additionally, sharp corners shown in the drawings may in reality be rounded. As such, the regions illustrated in the FIGs. are essentially schematic and are not intended to depict exact shapes, nor to limit the scope of the claimed invention.

Detailed reference will now be made to exemplary embodiments of the present invention, examples of which are illustrated in the accompanying drawings. Wherever possible, the same reference numerals are used throughout the drawings and description to refer to the same or like parts.

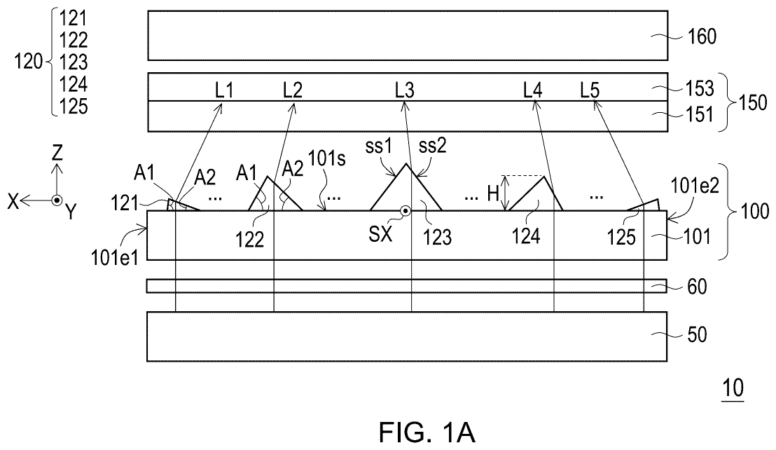

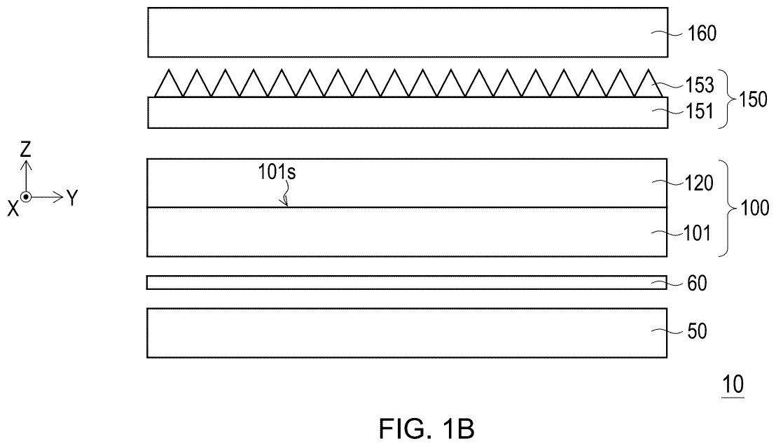

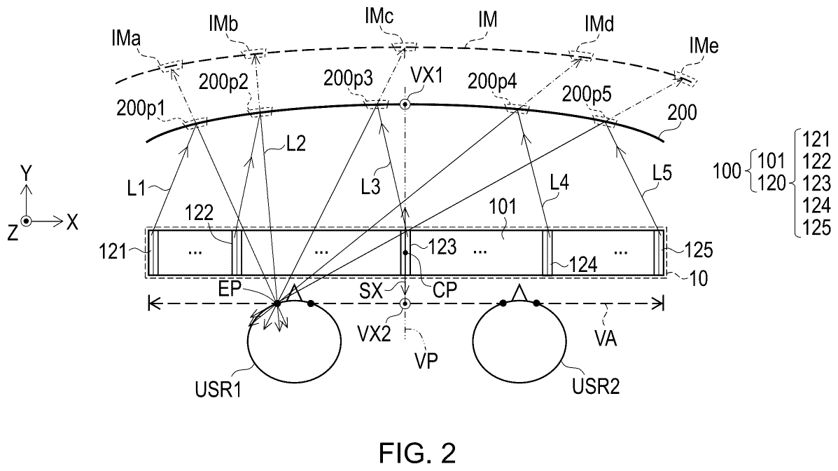

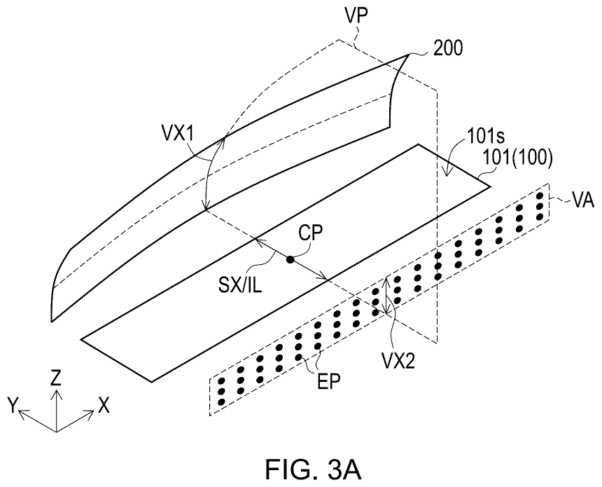

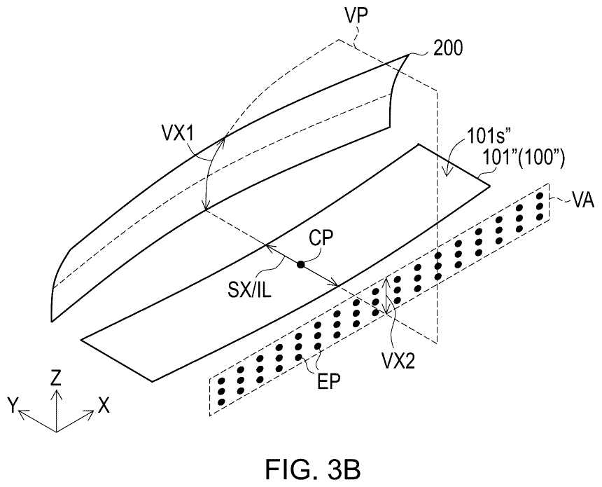

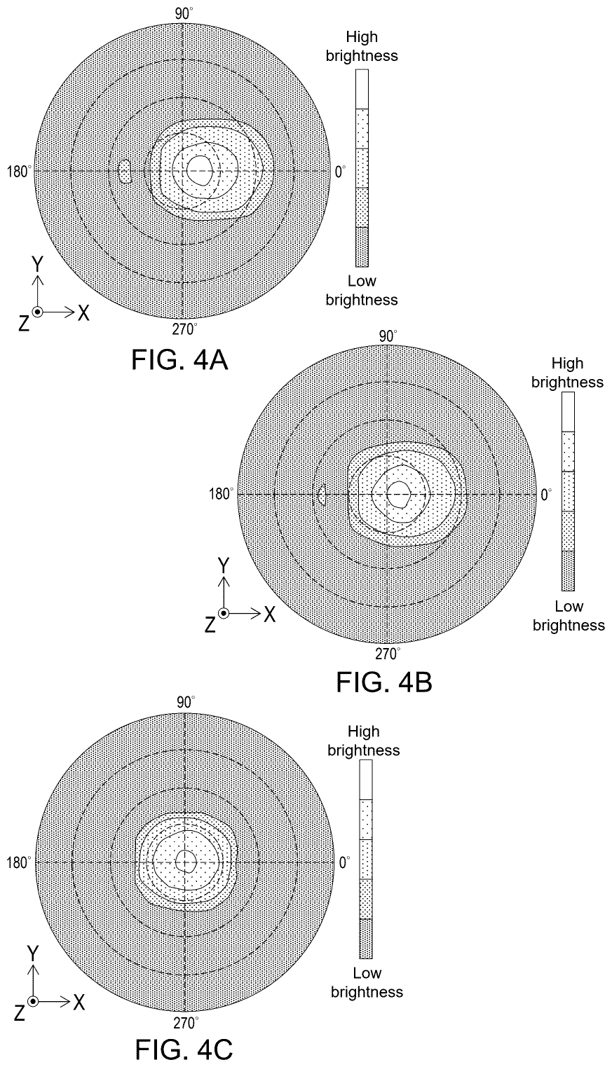

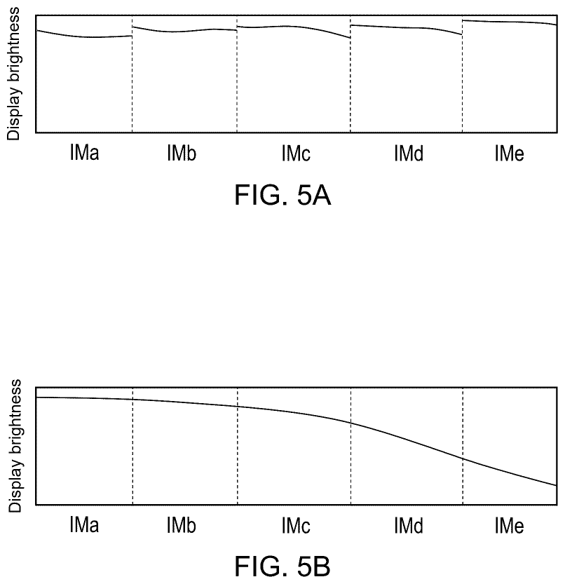

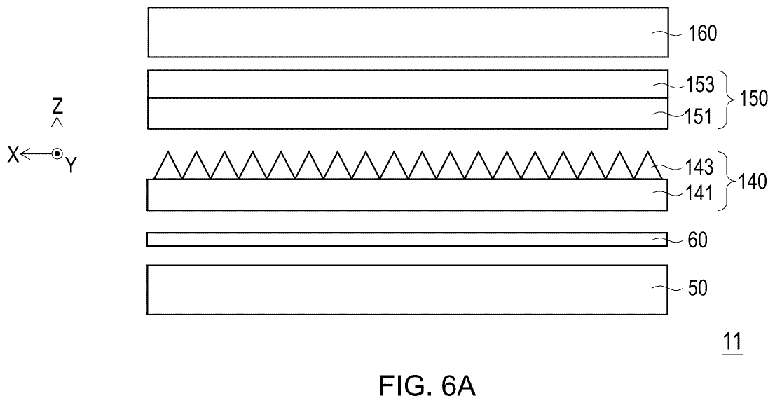

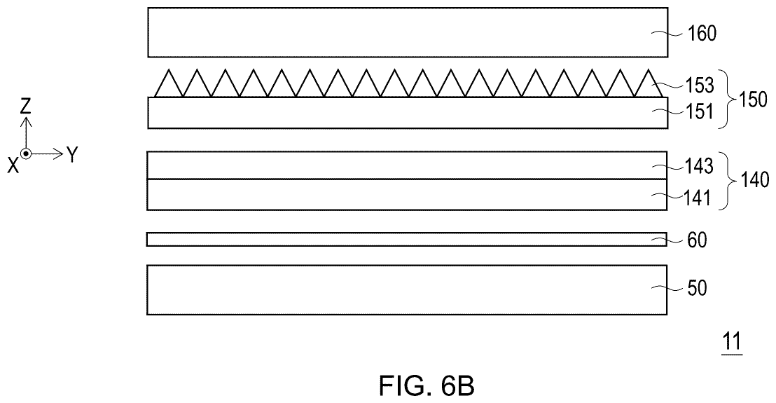

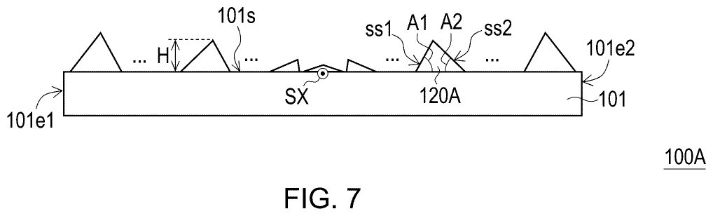

FIG. 1A and FIG. 1B are schematic cross-sectional views of a light source module according to a first embodiment of the disclosure. FIG. 2 is a schematic top view illustrating the configuration relationship between the optical film and the projection screen in FIG. 1. FIG. 3A is a schematic diagram illustrating the configuration relationship between the optical film, the projection screen and the viewing area in FIG. 2. FIG. 3B is a schematic diagram illustrating the configuration relationship between another embodiment of the optical film in FIG. 2, the projection screen and the viewing area. FIG. 4A to FIG. 4C illustrate light distributions of the light ray after passing through various prism structures in different regions of the optical film in FIG. 1. FIG. 5A is a display brightness distribution of a virtual image formed at an eye point in the viewing area after light passes through the optical film of FIG. 1 and is reflected by the projection screen. FIG. 5B is a display brightness distribution of a virtual image formed at an eye point in the viewing area after light passes through an optical film of a comparative example and is reflected by the projection screen. FIG. 6A and FIG. 6B are schematic cross-sectional views of an optical module of a comparative example. FIG. 7 is a schematic cross-sectional view of another embodiment of the optical film in FIG. 1A. For clarity, the light source module 10 in FIG. 2 only illustrates the optical film 100 of FIG. 1A.

Referring to FIG. 1A and FIG. 1B, an optical film 100 includes a substrate 101 and a plurality of prism structures 120. The plurality of prism structures 120 are, for example, arranged on a substrate surface 101s of the substrate 101 along a direction X and extend along a direction Y, where the direction X and the direction Y may optionally be perpendicular to each other, but the disclosure is not limited thereto. The substrate 101 is provided with a side edge 101e1 and a side edge 101e2 on opposite sides thereof along the direction X. Each of the prism structures 120 has a first structural surface ss1 and a second structural surface ss2 respectively facing the side edge 101e1 and the side edge 101e2. A first angle A1 is included between the first structural surface ss1 and the substrate surface 101s. A second angle A2 is included between the second structural surface ss2 and the substrate surface 101s.

It should be particularly noted that the structural surfaces of the prism structures 120 of the optical film 100 may form various angles relative to the substrate surface 101s. For example, in the embodiment, the substrate 101 is sequentially provided with a prism structure 121, a prism structure 122, a prism structure 123, a prism structure 124, and a prism structure 125 from the side edge 101e1 toward the side edge 101e2. These prism structures are symmetrically arranged relative to a structural axis SX on the substrate surface 101s, and the structural axis SX is parallel to the direction Y. It is first noted that, the structural axis SX of the embodiment is also a symmetry axis of the substrate 101 in the direction X, but the disclosure is not limited thereto.

The first angle A1 of each of the prism structures 121 to 125 decreases from the side edge 101e1 toward the side edge 101e2, and the second angle A2 decreases from the side edge 101e2 toward the side edge 101e1. For example, the first angle A1 of the prism structure 122, which is farther from the side edge 101e1, is smaller than the first angle A1 of the prism structure 121, which is closer to the side edge 101e1. The second angle A2 of the prism structure 121, which is farther from the side edge 101e2, is smaller than the second angle A2 of the prism structure 122, which is closer to the side edge 101e2.

From another perspective, a structural height H of each of the prism structures relative to the substrate surface 101s increases first and then decreases from the side edge 101e1 toward the side edge 101e2 of the substrate 101. In other words, the structural height H of each of the prism structures decreases from the structural axis SX toward either the side edge 101e1 or the side edge 101e2 of the substrate 101. In this way, the prism structures can be arranged on the substrate surface 101s with the same pitch, thereby avoiding the occurrence of moiré patterns when the optical film 100 is stacked with other films, which would otherwise affect the visual effect.

However, the disclosure is not limited thereto. As shown in FIG. 7, in another modified embodiment, the first angle A1 of each prism structure 120A of the optical film 100A increases from the structural axis SX toward the side edge 101e1 of the substrate 101, and the second angle A2 of each prism structure 120A increases from the structural axis SX toward the side edge 101e2 of the substrate 101. On the other hand, the structural height H of each prism structure 120A increases from the structural axis SX toward either the side edge 101e1 or the side edge 101e2 of the substrate 101.

It should be first noted that the light field distribution of light passing through the optical film 100 (or the optical film 100A in FIG. 7) of the embodiment is anisotropic. For example, in the embodiment, the plurality of prism structures 121 to 125 with five different angle designs can generate different light field distributions of light after passing through different regions of the optical film 100. The different regions herein, for example, are respectively provided with the plurality of prism structures 121 to 125, and each region is provided with a plurality of prism structures having the same angle design. However, the disclosure is not limited thereto. In other embodiments, the number of angle types of the prism structures of the optical film can be adjusted according to actual application requirements (e.g., number of divided regions).

Referring to FIGS. 1A to 3A, the optical film 100 is adapted for use in a light source module 10 and configured corresponding to a projection screen 200. In the embodiment, the projection screen 200 is, for example, a windshield or a side window of a vehicle, and the light source module 10 used in combination with the projection screen 200 may constitute a head-up display (HUD) for in-vehicle use, but the disclosure is not limited thereto. In other embodiments, the projection screen 200 may be a scenic window of a building.

For example, the light source module 10 may further include a light source 50, a diffusion sheet 60, a prism sheet 150, and an optical brightness enhancement film 160. The light source 50 is adapted to emit a plurality of light rays, such as light rays L1 to L5. The light source 50 may be, for example, a light board provided with a plurality of light-emitting elements (e.g., light-emitting diodes) arranged in an array, but the disclosure is not limited thereto. The optical film 100 is disposed on one side of a light-emitting surface of the light source 50 and is located on the transmission path of the light rays. The diffusion sheet 60 may optionally be disposed between the optical film 100 and the light source 50. The optical brightness enhancement film 160 is disposed on one side of the optical film 100 facing away from the light source 50. The prism sheet 150 is disposed between the optical film 100 and the optical brightness enhancement film 160. The optical brightness enhancement film 160 may be, for example, a dual brightness enhancement film (DBEF) produced by 3M, but the disclosure is not limited thereto. In addition, a cavity structure as disclosed in U.S. Pat. No. 8,390,760 may also be disposed between the diffusion sheet 60 and the light source 50.

The prism sheet 150 may include a substrate 151 and a plurality of prism structures 153. In the embodiment, the prism structures 153 may be arranged on the substrate 151 along the direction Y and extend along the direction X. That is, the arrangement direction of the prism structures 153 of the prism sheet 150 may be perpendicular to the arrangement direction of the prism structures 120 of the optical film 100. It should be noted that, unlike the optical film 100, the two structural surfaces of each prism structure 153 of the prism sheet 150 are symmetrically arranged and are configured to enhance the light convergence of the light source module 10 along the direction Y.

For example, the light source module 10 may be disposed on a platform between a vehicle's dashboard and windshield and project multiple light rays L1 to L5 toward the projection screen 200. These light rays L1 to L5, after being reflected by the projection screen 200, are transmitted into a viewing area VA composed of multiple eye points EP. The light rays L1 to L5 are received by a user USR1 (e.g., a driver) or a user USR2 (e.g., a passenger in the front seat) at any eye point EP in the viewing area VA, and a virtual image IM is formed behind the projection screen 200 as shown in FIG. 2.

In the embodiment, the viewing area VA has a width along the direction X that may simultaneously cover both users USR1 and USR2, but the disclosure is not limited thereto. The projection screen 200 and the viewing area VA respectively have an upright axis VX1 and an upright axis VX2, and the upright axis VX2 of the viewing area VA faces the upright axis VX1 of the projection screen 200 along the direction Y. The upright axes VX1 and VX2 may define a virtual plane VP. The virtual plane VP intersects the substrate surface 101s at an intersection line IL having a midpoint CP. The structural axis SX passes through the midpoint CP of the intersection line IL and extends along the direction Y. More specifically, in the embodiment, the structural axis SX overlaps (or coincides with) the intersection line IL, but the disclosure is not limited thereto.

In the embodiment, the projection screen 200 may include a plurality of portions 200p1 to 200p5. The multiple light rays L1 to L5 emitted from the light source 50 are respectively projected onto the plurality of portions 200p1 to 200p5 of the projection screen 200 after passing through the plurality of prism structures 121 to 125 of the optical film 100. Theses light rays L1 to L5, after being reflected respectively by the plurality of portions 200p1 to 200p5 of the projection screen 200, form multiple partial virtual images IMa to IMe constituting the aforementioned virtual image IM at any eye point EP in the viewing area VA.

It should be first noted that, since the projection screen 200 is a curved surface, different portions (e.g., the portions 200p1 to 200p5) thereof arranged along the direction X may have different reflectance for light rays incident from the same direction. Therefore, light rays with uniform light field distribution may form a non-uniform light field distribution after being reflected by the projection screen 200. For example, in a light source module 11 (as shown in FIGS. 6A and 6B) of a comparative example, another prism sheet 140 is used to replace the optical film 100 in the light source module 10 of the embodiment. Similar to the prism sheet 150, the prism sheet 140 may include a substrate 141 and a plurality of prism structures 143. In the comparative example, the prism structures 143 may be arranged on the substrate 141 along the direction X and extend along the direction Y. That is, the arrangement direction of the prism structures 143 of the prism sheet 140 may be perpendicular to the arrangement direction of the prism structures 153 of the prism sheet 150. The two structural surfaces of each prism structure 143 of the prism sheet 140 are symmetrically arranged and configured to enhance light convergence of the light source module 11 along the direction X.

Through the stacked arrangement of the prism sheet 140 and the prism sheet 150, the light rays emitted from the light source module 11 of the comparative example can exhibit better light convergence and more uniform light field distribution in both the direction X and the direction Y. However, after being reflected by the projection screen 200 shown in FIG. 2 to any eye point EP, the uniform light field distribution may become non-uniform. The display brightnesses of a plurality of partial virtual images of the virtual image IM formed by the light rays with non-uniform light field distribution at any eye point EP in the viewing area VA may have significant differences. As shown in FIG. 2 and FIG. 5B, for the user USR1, the display brightness of the virtual image IM decreases from the partial virtual image IMa toward the partial virtual image IMe.

However, in the light source module 10 of the embodiment, the angles of the prism structures of the optical film 100 vary depending on their placement regions on the substrate 101. Therefore, the light distribution of light rays after passing through prism structures with different angles is also different. For example, the light ray L1, after passing through the prism structures 121 closer to the side edge 101e1 of the substrate 101, exhibits the largest rightward shift relative to the forward light-emitting direction (e.g., the direction Z in FIG. 2) of the light source module 10 (as shown in FIG. 4A). The light ray L2, after passing through the prism structures 122 slightly farther from the side edge 101e1, exhibits the second largest rightward shift relative to the forward light-emitting direction of the light source module 10 (as shown in FIG. 4B), and the light ray L3, after passing through the prism structures 123 farthest from both side edges 101e1 and 101e2 of the substrate 101, exhibits a symmetric distribution relative to the forward light-emitting direction of the light source module 10 (as shown in FIG. 4C).

It should be noted that, although not illustrated, the light distribution of the light ray L5, after passing through the plurality of prism structures 125 closest to the side edge 101e2 of the substrate 101, exhibits the largest leftward shift relative to the forward light-emitting direction of the light source module 10, and the amount of leftward shift is similar to the amount of rightward shift shown in FIG. 4A. The light distribution of the light ray L4, after passing through the plurality of prism structures 124 next closest to the side edge 101e2 of the substrate 101, exhibits the second largest leftward shift relative to the forward light-emitting direction of the light source module 10, and the amount of leftward shift is similar to the amount of rightward shift shown in FIG. 4B.

In other words, the light distributions of the multiple light rays L1 to L5 after passing through the optical film 100 are different from each other. That is, the overall light field distribution of the light rays after passing through the optical film 100 of the embodiment is anisotropic. For example, the light intensity of the light ray L1 entering the portion 200p1 of the projection screen 200, the light intensity of the light ray L2 entering the portion 200p2 of the projection screen 200, the light intensity of the light ray L3 entering the portion 200p3 of the projection screen 200, the light intensity of the light ray L4 entering the portion 200p4 of the projection screen 200, and the light intensity of the light ray L5 entering the portion 200p5 of the projection screen 200 may differ from each other.

Since the projection screen 200 is a curved surface, its different portions (e.g., the plurality of portions 200p1 to 200p5) arranged along the direction X may have different reflectance for light rays incident from the same direction. By allowing the light rays L1 to L5 to enter the projection screen 200 with different light intensities, the plurality of partial virtual images IMa to IMe respectively formed by the light rays L1 to L5, after being reflected by the plurality of portions 200p1 to 200p5 of the projection screen 200, at any eye point EP in the viewing area VA can have equal or substantially equal display brightness, as shown in FIG. 5A. That is, compared to the light source module 11 of the comparative example (as shown in FIGS. 6A and 6B), the virtual image IM projected on the projection screen 200 adopting the optical module 10 of the embodiment can have a more uniform display brightness distribution.

It is worth mentioning that the respective geometries of the plurality of prism structures 120 of the embodiment are not identical, and are symmetrically arranged relative to the structural axis SX on the substrate surface 101s (e.g., the prism structure 121 and the prism structure 125, or the prism structure 122 and the prism structure 124). The effectiveness of this configuration can be illustrated by comparing the comparative example (as shown in FIGS. 5B and 6A) with the embodiment (as shown in FIGS. 5A and 1A). In the light source module 11 of the comparative example, the plurality of prism structures on the prism sheet 140 all have symmetric and identical geometries. This structural design causes the display brightness of the partial virtual image IMa to be significantly greater than the display brightness of the partial virtual image IMe. However, in the light source module 10 of the embodiment, the respective geometries of the prism structures on the optical film 100 are not identical, and are symmetrically arranged relative to the structural axis SX on the substrate surface 101s. For example, the prism structure 121 having an asymmetric structural surface design can significantly reduce the display brightness of the partial virtual image IMa in FIG. 5A compared to that in FIG. 5B, while the prism structure 125, which is symmetrically arranged with respect to the prism structure 121 and also has an asymmetric structural design, can significantly increase the display brightness of the partial virtual image IMe in FIG. 5A compared to that in FIG. 5B, making it close to the display brightness of the partial virtual image IMa in FIG. 5A. Similarly, the technical effect of making the display brightness of the partial virtual images IMb and IMd approximately equal can be achieved through the symmetrically arranged prism structures 122 and 124 with asymmetric structural surface designs relative to the structural axis SX, thereby improving the overall display uniformity of the partial virtual images IMa to IMe and solving the problem of poor display uniformity in conventional virtual images.

In addition, as shown in FIG. 1A, in the embodiment, a sum of the first angle A1 and the second angle A2 of each prism structure 120 of the optical film 100 may be equal. For example, a sum of the angles A1 and A2 of the prism structure 121 is equal to a sum of the angles A1 and A2 of the prism structure 122. Therefore, when fabricating the mold for producing the optical film 100, only one cutting tool may be used, and the mold can be completed by sequentially rotating the tool angle, which helps simplify the mold fabrication process.

Referring to FIG. 3B, in an optical film 100″ according to another embodiment of the optical film 100 shown in FIG. 2, the substrate surface 101s″ of the substrate 101″ may be a curved surface recessed in a direction opposite to direction Z. In other words, the light field distribution of the light ray after passing through the substrate 101″ is non-uniform. Therefore, it is even more necessary to employ the angle distribution design of the prism structures to ensure that the virtual image formed at any eye point EP in the viewing area VA by the light rays reflected from different portions of the projection screen 200 has a more uniform display brightness distribution.

Some other embodiments of the disclosure will be described below in detail. The same components are labeled with the same reference numerals, and repeated technical descriptions will be omitted. Please refer to the aforementioned embodiment for the omitted portions, which will not be redundantly described herein.

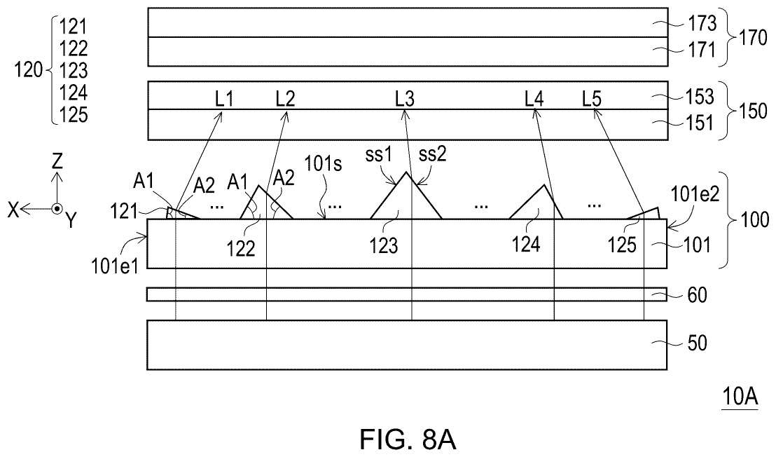

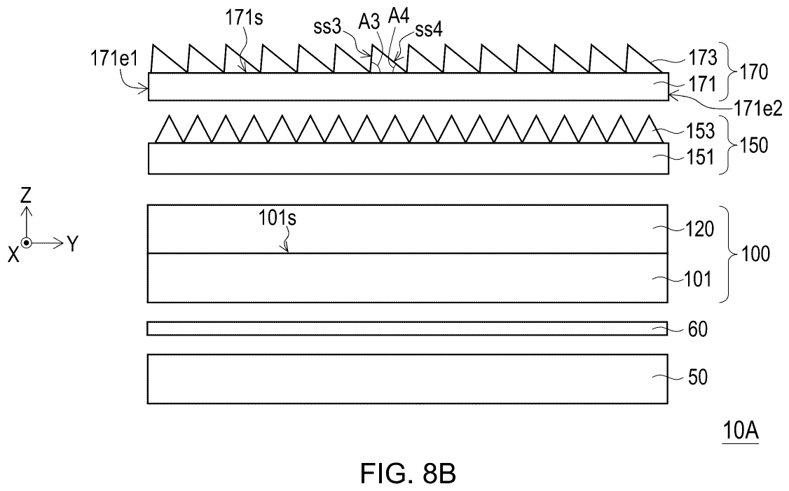

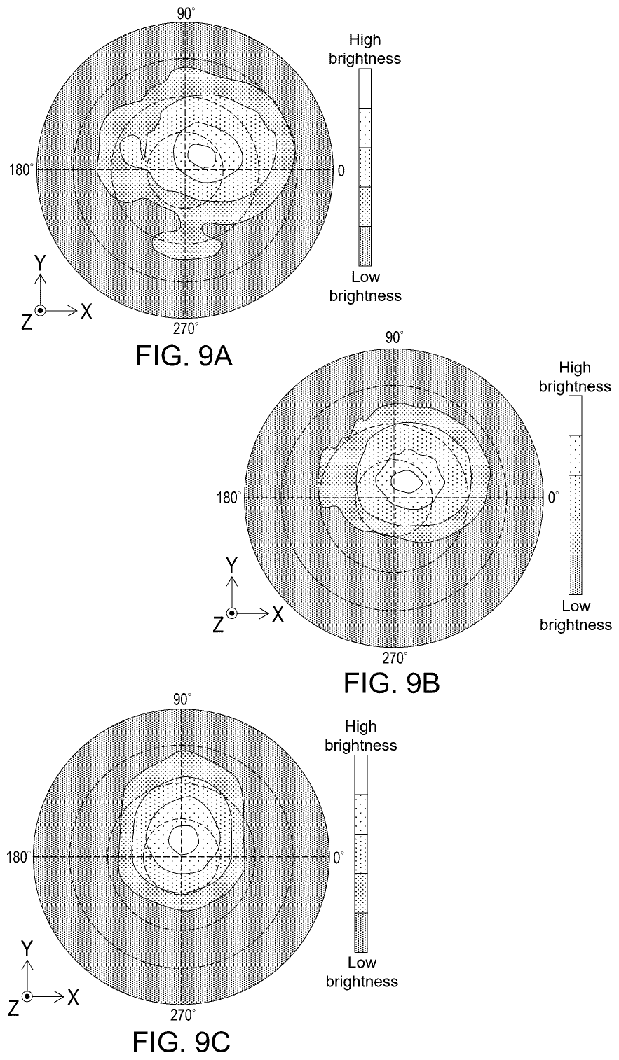

FIG. 8A and FIG. 8B are schematic cross-sectional views of a light source module according to a second embodiment of the disclosure. FIG. 9A to FIG. 9C illustrate light distribution of the light ray after passing through the plurality of prism structures in different regions of the optical film in FIG. 8A and FIG. 8B and the light pattern shifting film. Referring to FIGS. 3A, 8A, and 8B, unlike the light source module 10 in FIGS. 1A and 1B, a light source module 10A of the embodiment adopts a light pattern shifting film 170 in place of the optical brightness enhancement film 160 shown in FIG. 1A. That is, the light pattern shifting film 170 is disposed on the side of the prism sheet 150 facing away from the optical film 100 and overlaps the optical film 100.

In the embodiment, the light pattern shifting film 170 includes a substrate 171 and a plurality of optical microstructures 173. These optical microstructures 173 are arranged on a substrate surface 171s of the substrate 171 along the direction Y and extend along the direction X. The substrate 171 is provided with a side edge 171e1 and a side edge 171e2 on opposite sides thereof along the direction Y. Each of the optical microstructures 173 has a structural surface ss3 facing the side edge 171e1 of the substrate 171 and a structural surface ss4 facing the side edge 171e2. An angle A3 included between the structural surface ss3 of each optical microstructure 173 and the substrate surface 171s is the same. An angle A4 included between the structural surface ss4 of each optical microstructure 173 and the substrate surface 171s is the same. The angle A3 is different from the angle A4. For example, in the embodiment, the angle A3 may be greater than the angle A4, but the disclosure is not limited thereto.

The configuration of the light pattern shifting film 170 can further shift the light distribution in the direction Y. By comparing FIGS. 9A, 9B, and 9C with FIGS. 4A, 4B, and 4C, respectively, it can be seen that if the light rays further pass through the light pattern shifting film 170 of the embodiment, the light distribution is generally shifted in the direction Y. As shown in FIG. 3A, since the projection screen 200 is a toric surface (i.e., the curvature of the projection screen 200 along the direction X is different from that along the direction Z), shifting the light distribution in the direction Y using the light pattern shifting film 170 can further improve the brightness uniformity of the displayed virtual image (such as the virtual image IM shown in FIG. 2) along the direction Z.

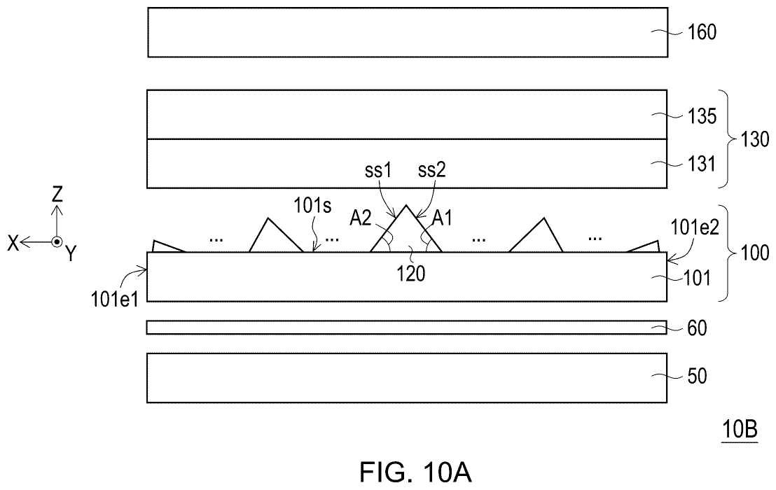

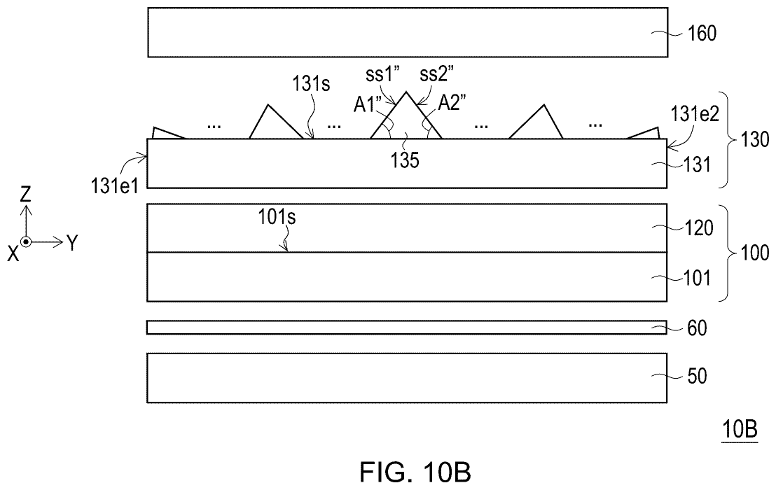

FIG. 10A and FIG. 10B are schematic cross-sectional views of a light source module according to a third embodiment of the disclosure. Referring to FIGS. 10A and 10B, in the embodiment, a light source module 10B adopts another optical film 130 in place of the prism sheet 150 shown in FIGS. 1A and 1B. The structural design and function of the optical film 130 are similar to those of the optical film 100. More specifically, the light field distribution of the light ray after passing through the optical film 130 is also non-uniform, and the influence of the optical film 130 and the optical film 100 on the light field distribution occurs in different spatial dimensions. For example, the optical film 100 affects the light field distribution in the direction X, while the optical film 130 affects the light field distribution in the direction Y.

In detail, the optical film 130 may include a substrate 131 and a plurality of prism structures 135. These prism structures 135 are arranged on a substrate surface 131s of the substrate 131 along the direction Y and extend along the direction X. That is, the arrangement direction of the prism structures 120 of the optical film 100 may be perpendicular to the arrangement direction of the prism structures 135 of the optical film 130. The substrate 131 is provided with a side edge 131e1 and a side edge 131e2 on opposite sides thereof along the direction Y. Each prism structure 135 has a structural surface ss1″ facing the side edge 131e1 and a structural surface ss2″ facing the side edge 131e2. An angle A1″ is included between each structural surface ss1″ and the substrate surface 131s. An angle A2″ is included between each structural surface ss2″ and the substrate surface 131s. In the embodiment, since the distribution of the angle A1″ and the angle A2″ of each prism structure 135 of the optical film 130 is similar to that of the optical film 100, a detailed description can be found in the relevant paragraphs of the aforementioned embodiments and will not be repeated here.

It is particularly noted that when the width of the projection screen 200 of FIG. 3A in the direction Z is increased (for example, doubled), different portions of the projection screen 200 arranged along the direction Z will have different reflectances for light rays incident from the same direction. Therefore, through the configuration of the above-described optical film 130, the overall light field distribution of the light source module 10B in the direction Y can also become non-uniform. As such, the brightness uniformity of the displayed virtual image (such as the virtual image IM shown in FIG. 2) in the direction Z can be further improved.

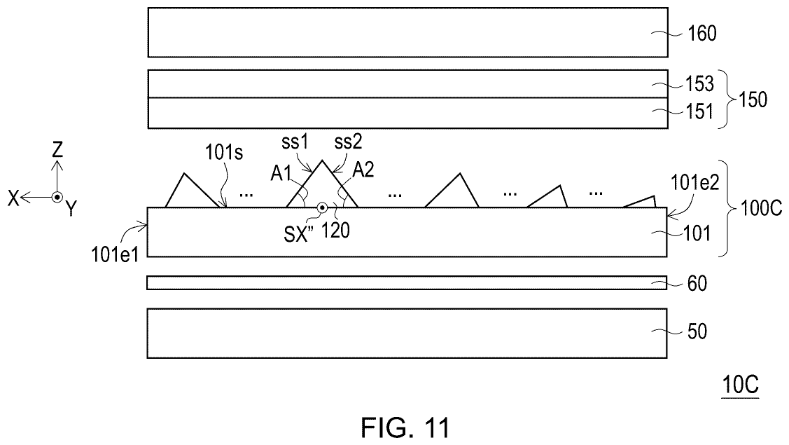

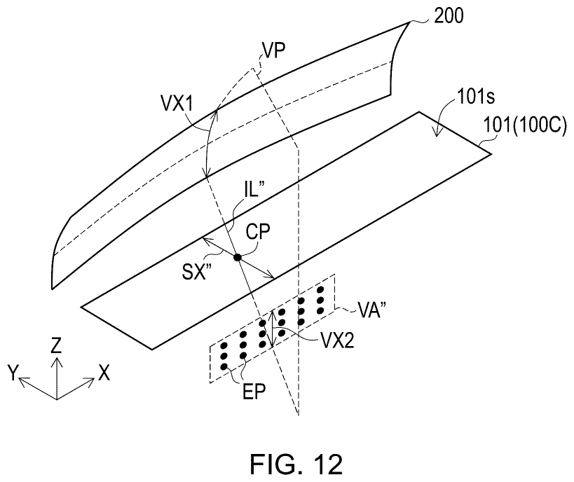

FIG. 11 is a schematic cross-sectional view of a light source module according to a fourth embodiment of the disclosure. FIG. 12 is a schematic diagram illustrating the configuration relationship between the optical film, the projection screen, and the viewing area in FIG. 11. Referring to FIGS. 11 and 12, the difference between a light source module 10C of the embodiment and the light source module 10 in FIG. 1A lies in the position of the structural axis of the optical film on the substrate surface. Specifically, the structural axis SX″ of the embodiment does not overlap the symmetry axis of the substrate 101 in the direction X. That is, the structural axis SX″ is arranged offset from the symmetry axis of the substrate 101.

For example, in the embodiment, the width of the viewing area VA″ along the direction X is, for example, one third of that of the viewing area VA in FIG. 3A, and it is configured only for the user USR1. In other words, the upright axis VX2 of the viewing area VA″ does not face the upright axis VX1 of the projection screen 200 along the direction Y. The virtual plane VP formed by the upright axes VX1 and VX2 intersects the substrate surface 101s at the intersection line IL″ which intersects the structural axis SX″.

It is particularly noted that the midpoint CP of the intersection line IL″ defines the position of the structural axis SX″ on the substrate surface 101s along the direction X. The plurality of prism structures 120 of the optical film 100C are symmetrically arranged relative to the structural axis SX″. In other words, the position of the mirror-symmetric center (i.e., the structural axis) of the prism structure distribution of the optical film can be adjusted according to different application requirements (e.g., single-user or multi-user usage) to optimize the brightness uniformity of the displayed virtual image.

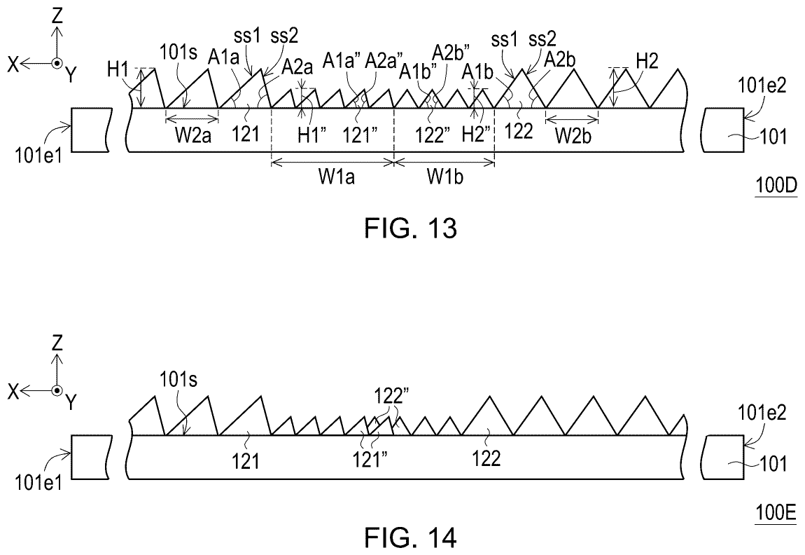

FIG. 13 is a schematic cross-sectional view of an optical film according to a fifth embodiment of the disclosure. FIG. 14 is a schematic cross-sectional view of another embodiment of the optical film in FIG. 13. Referring to FIG. 13, in the embodiment, the substrate 101 of the optical film 100D is provided with a plurality of prism structures 121 and a plurality of prism structures 122. These prism structures are arranged on the substrate surface 101s of the substrate 101 along the direction X and extend along the direction Y. The angle A1a of the prism structures 121 is not equal to the angle A1b of the prism structures 122. The angle A2a of the prism structures 121 is not equal to the angle A2b of the prism structures 122.

Due to the different structural designs of the prism structures 121 and 122 (i.e., different angles between the structural surfaces and the substrate surface 101s), tool changes are required during fabrication of the prism structures with different angles. However, tool changes may easily introduce alignment tolerances, causing partial overlaps between the two types of prism structures with different angles, resulting in noticeable bright stripes on the film surface appearance, or gaps between the two types of prism structures, resulting in noticeable dark stripes on the film surface appearance.

To solve the aforementioned problem, in the embodiment, a plurality of prism structures 121″ and a plurality of prism structures 122″ may be further provided between the prism structures 121 and the prism structures 122. The plurality of prism structures 121″ are disposed adjacent to the prism structures 121, and the plurality of prism structures 122″ are disposed adjacent to the prism structures 122. It is particularly noted that the prism structures 121″ and the prism structures 121 may be processed using the same tool, and the prism structures 122″ and the prism structures 122 may be processed using the same tool. Therefore, the angle A1a″ and the angle A2a″ of the prism structure 121″ may be equal to the angle A1a and the angle A2a of the prism structure 121, respectively, and the angle A1b″ and the angle A2b″ of the prism structures 122″ may be equal to the angle A1b and the angle A2b of the prism structures 122, respectively.

It is particularly noted that a structural height H1″ of the prism structures 121″ is smaller than a structural height H1 of the prism structures 121, and a structural height H2″ of the prism structures 122″ is smaller than a structural height H2 of the prism structures 122. Since the dimensions of the prism structures 121″ and 122″ are significantly smaller than those of the prism structures 121 and 122, even if partial overlap occurs between the prism structures 121″ and the prism structures 122″ due to alignment tolerance during the tool change process, the resulting bright stripes on the film surface appearance are not obvious. In other words, the regions where the prism structures 121″ and 122″ are disposed can serve as a buffer area for the tool change process during the segmented processing of the prism structures 121 and 122, thereby enhancing the process flexibility and surface appearance quality of the optical film 100D.

However, the disclosure is not limited thereto. In other embodiments, only the plurality of prism structures 121″ or the plurality of prism structures 122″ may be provided between the arrangement regions of the plurality of prism structures 121 and the plurality of prism structures 122. Even if a misalignment occurs during the tool change process such that part of the prism structures 121″ overlaps part of the prism structures 122, or part of the prism structures 122″ overlaps part of the prism structures 121, the bright stripes formed on the surface of the film may become inconspicuous due to the large structural size difference between the overlapping prism structures. Thus, a similar technical effect as that of the embodiment can also be achieved. In the embodiment, the plurality of prism structures 121″ have a width W1a along the direction X, and the plurality of prism structures 122″ have a width W1b along the direction X. Each of the prism structures 121 has a width W2a along the direction X, and each of the prism structures 122 has a width W2b along the direction X. Preferably, a ratio of the width W1a to the width W2a and a ratio of the width W1b to the width W2b are greater than or equal to 0.1 and less than 1.

It is particularly noted that the technical means disclosed in the embodiment may be applied to the splicing regions between any two types of prism structures in the aforementioned embodiments, such as the splicing region between the prism structures 122 and 123, the splicing region between the prism structures 123 and 124, and/or the splicing region between the prism structures 124 and 125 in FIG. 1A, so as to achieve a similar technical effect to that of the embodiment.

The optical film 100D disclosed in FIG. 13 represents a configuration formed without misalignment during the tool change process. If misalignment occurs during the tool change process, an optical film 100E as shown in FIG. 14 will be produced. In the optical film 100E, the arrangement region of the plurality of prism structures 121″ partially overlaps the arrangement region of the plurality of prism structures 122″. That is, part of the prism structures 121″ and part of the prism structures 122″ are alternately arranged along the direction X.

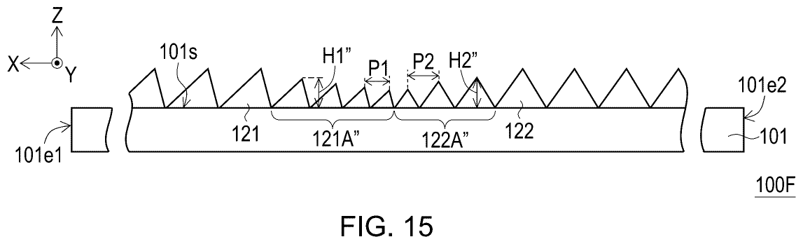

FIG. 15 is a schematic cross-sectional view of an optical film according to a sixth embodiment of the disclosure. Referring to FIG. 15, unlike the optical film 100D in FIG. 13, in an optical film 100F of the embodiment, the structural height H1″ of each of the plurality of prism structures 121A″ decreases as a distance from the plurality of prism structures 121 increases, and the structural height H2″ of each of the plurality of prism structures 122A″ decreases as a distance from the plurality of prism structures 122 increases.

From another perspective, any two adjacent ones of the plurality of prism structures 121A″ are arranged with a pitch P1, and the pitch P1 decreases as a distance from the plurality of prism structures 121 increases. Similarly, any two adjacent ones of the plurality of prism structures 122A″ are arranged with a pitch P2, and the pitch P2 decreases as a distance from the plurality of prism structures 122 increases. Through the gradient design of structural height and arrangement pitch of the plurality of prism structures 121A″ (or the plurality of prism structures 122A″), it is possible to effectively prevent problems such as structural chipping or poor formation of the prism structures 121A″ and the prism structures 122A″ caused by poor fluidity of photoresist in the photolithography imprinting process.

It should be noted that the gradient pattern of the structural height reduction of the prism structures 121A″ and the prism structures 122A″ may be adjusted according to different process requirements or material selections, and is not limited by the disclosure.

In summary, in the optical film of an embodiment of the disclosure, the geometric shape or structural height of each of the prism structures varies according to its position on the substrate. The geometric shape distribution or structural height distribution of these prism structures allows light passing through the respective structural surfaces to be incident on different portions of the projection screen with different light intensities. After being reflected by different portions of the projection screen, the virtual image formed at any eye point within the viewing area can exhibit a more uniform display brightness distribution. In the optical film of an embodiment of the disclosure, a third prism structure is provided between the first prism structure and the second prism structure having different angles. Since the angle of the third prism structure is the same as that of either the first prism structure or the second prism structure, and the structural height of the third prism structure is less than that of the first prism structure and second prism structure, the region in which the third prism structure is provided can serve as a buffer area for the segmented processing of the first prism structure and second prism structure. This contributes to improved process flexibility, and the produced optical film can have a desirable film surface appearance.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An optical film, adapted for use in a light source module and configured corresponding to a projection screen, wherein the projection screen has a viewing area formed by a plurality of eye points, and the optical film comprises:
a first substrate, having a first side edge and a second side edge on opposite sides thereof along a first direction; and
a plurality of prism structures, arranged on a first substrate surface of the first substrate along the first direction and extending along a second direction, wherein the plurality of prism structures comprises a first prism structure and a second prism structure having mutually different geometrical shapes,
wherein a light source of the light source module is configured to emit a first light ray and a second light ray, the first light ray is incident on a first portion of the projection screen with a first light intensity after passing through the first prism structure, the second light ray is incident on a second portion of the projection screen with a second light intensity after passing through the second prism structure, the first light intensity is not equal to the second light intensity, a portion of a virtual image formed at any one of the plurality of eye points by the first light ray having the first light intensity and reflected from the first portion of the projection screen has a first display brightness, another portion of the virtual image formed at the any one of the plurality of eye points by the second light ray having the second light intensity and reflected from the second portion of the projection screen has a second display brightness, and the first display brightness is equal to the second display brightness.

2. The optical film according to claim 1, wherein each of the plurality of prism structures has a first structural surface and a second structural surface respectively facing the first side edge and the second side edge, a first angle is included between the first structural surface and the first substrate surface, and the first angle of the first prism structure is different from the first angle of the second prism structure.

3. The optical film according to claim 2, wherein a second angle is included between the second structural surface and the first substrate surface, and a sum of the first angle and the second angle of the first prism structure is equal to a sum of the first angle and the second angle of the second prism structure.

4. The optical film according to claim 2, wherein the projection screen further has a first upright axis, and the viewing area has a second upright axis, the first upright axis and the second upright axis form a virtual plane, the virtual plane intersects the first substrate surface at an intersection line having a midpoint, the first substrate surface is provided with a structural axis passing through the midpoint and extending in the second direction, and the plurality of prism structures are symmetrically arranged relative to the structural axis.

5. The optical film according to claim 4, wherein a second angle is included between the second structural surface and the first substrate surface, the first angle of each of the plurality of prism structures decreases from the first side edge toward the second side edge, and the second angle of each of the plurality of prism structures decreases from the second side edge toward the first side edge.

6. The optical film according to claim 5, wherein each of the plurality of prism structures has a structural height relative to the first substrate surface, and the structural height of each of the plurality of prism structures decreases from the structural axis toward the first side edge or the second side edge.

7. The optical film according to claim 4, wherein the structural axis overlaps the intersection line.

8. The optical film according to claim 4, wherein the structural axis intersects the intersection line.

9. The optical film according to claim 1, wherein the light source module further includes a light pattern shifting film disposed overlapping the optical film, the light pattern shifting film including a second substrate and a plurality of optical microstructures, the plurality of optical microstructures are arranged on a second substrate surface of the second substrate along the second direction and extending in the first direction, the second substrate has a third side edge and a fourth side edge on opposite sides thereof along the second direction, each of the plurality of optical microstructures has a third structural surface and a fourth structural surface respectively facing the third side edge and the fourth side edge, a third angle included between the third structural surface of each of the plurality of optical microstructures and the second substrate surface is the same, a fourth angle included between the fourth structural surface of each of the plurality of optical microstructures and the second substrate surface is the same, and the third angle is different from the fourth angle.

10. An optical film, comprising:
a first substrate; and
a plurality of prism structures, arranged on a first substrate surface of the first substrate along a first direction and extending along a second direction, wherein the first substrate has a first side edge and a second side edge on opposite sides thereof along the first direction, each of the plurality of prism structures has a structural height relative to the first substrate surface, and the structural height of each of the plurality of prism structures increases first and then decreases from the first side edge toward the second side edge.

11. The optical film according to claim 10, wherein each of the plurality of prism structures has a first structural surface and a second structural surface respectively facing the first side edge and the second side edge, a first angle included between the first structural surface of each of the plurality of prism structures and the first substrate surface decreases from the first side edge toward the second side edge, and a second angle included between the second structural surface of each of the plurality of prism structures and the first substrate surface decreases from the second side edge toward the first side edge.

12. The optical film according to claim 10, adapted for use in a light source module and configured corresponding to a projection screen, wherein the plurality of prism structures includes a first prism structure and a second prism structure, a light source of the light source module is configured to emit a first light ray and a second light ray, the first light ray is incident on a first portion of the projection screen with a first light intensity after passing through the first prism structure, and the second light ray is incident on a second portion of the projection screen with a second light intensity after passing through the second prism structure, the first light intensity is different from the second light intensity, a portion of a virtual image formed in a viewing area of the projection screen by the first light ray having the first light intensity and reflected from the first portion of the projection screen has a first display brightness, and another portion of the virtual image formed in the viewing area of the projection screen by the second light ray having the second light intensity and reflected from the second portion of the projection screen has a second display brightness, wherein the first display brightness is equal to the second display brightness.

13. The optical film according to claim 12, wherein the projection screen further has a first upright axis, and the viewing area has a second upright axis, the first upright axis and the second upright axis form a virtual plane, the virtual plane intersects the first substrate surface at an intersection line having a midpoint, the first substrate surface is provided with a structural axis passing through the midpoint and extending in the second direction, and the plurality of prism structures are symmetrically arranged relative to the structural axis.

14. The optical film according to claim 13, wherein the structural axis intersects the intersection line.

15. The optical film according to claim 12, wherein the light source module further includes a light pattern shifting film disposed overlapping the optical film, the light pattern shifting film includes a second substrate and a plurality of optical microstructures, the plurality of optical microstructures are arranged on a second substrate surface of the second substrate along the second direction and extending in the first direction, the second substrate has a third side edge and a fourth side edge on opposite sides thereof along the second direction, each of the plurality of optical microstructures has a third structural surface and a fourth structural surface respectively facing the third side edge and the fourth side edge, a third angle included between the third structural surface of each of the plurality of optical microstructures and the second substrate surface is the same, a fourth angle included between the fourth structural surface of each of the plurality of optical microstructures and the second substrate surface is the same, and the third angle is different from the fourth angle.

16. An optical film, comprising:
a substrate, having a first side edge and a second side edge on opposite sides thereof along a first direction; and
a plurality of prism structures, arranged on a substrate surface of the substrate along the first direction and extending along a second direction, wherein each of the plurality of prism structures has a structural height relative to the substrate surface, and a first structural surface and a second structural surface respectively facing the first side edge and the second side edge, a first angle is included between the first structural surface and the substrate surface, a second angle is included between the second structural surface and the substrate surface, the plurality of prism structures include a plurality of first prism structures, a plurality of second prism structures, and a plurality of third prism structures, and at least a portion of the plurality of third prism structures is disposed between each of the plurality of first prism structures and each of the plurality of second prism structures,
wherein the first angle of each of the plurality of third prism structures is equal to the first angle of each of the plurality of first prism structures and different from the first angle of each of the plurality of second prism structures, the second angle of each of the plurality of third prism structures is equal to the second angle of each of the plurality of first prism structures and different from the second angle of each of the plurality of second prism structures, and the structural height of each of the plurality of third prism structures is less than the structural height of each of the plurality of first prism structures and the plurality of second prism structures.

17. The optical film according to claim 16, wherein the plurality of prism structures further include a plurality of fourth prism structures disposed between the at least a portion of the plurality of third prism structures and each of the plurality of second prism structures, the first angle of each of the plurality of fourth prism structures is equal to the first angle of each of the plurality of second prism structures and different from the first angle of each of the plurality of first prism structures, the second angle of each of the plurality of fourth prism structures is equal to the second angle of each of the plurality of second prism structures and different from the second angle of each of the plurality of first prism structures, and the structural height of each of the plurality of fourth prism structures is less than the structural height of each of the plurality of first prism structures and the plurality of second prism structures.

18. The optical film according to claim 17, wherein the structural height of each of the plurality of third prism structures decreases as a distance from the plurality of first prism structures increases, and the structural height of each of the plurality of fourth prism structures decreases as a distance from the plurality of second prism structures increases.

19. The optical film according to claim 18, wherein any two adjacent ones of the plurality of third prism structures are arranged with a first pitch, the first pitch decreases as the distance from the plurality of first prism structures increases, any two adjacent ones of the plurality of fourth prism structures are arranged with a second pitch, and the second pitch decreases as the distance from the plurality of second prism structures increases.

20. The optical film according to claim 16, wherein the plurality of third prism structures have a first width along the first direction, each of the plurality of first prism structures has a second width along the first direction, and a ratio of the first width to the second width is greater than or equal to 0.1 and less than or equal to 1.
